(19) United States
(12) Patent Application Publication
(10) Pub. No.: US 2024/0288008 A1
(43) Pub. Date: Aug. 29, 2024

(54) HYDRAULIC ASSEMBLY FOR SUPPLYING AN ATTACHMENT WITH HYDRAULIC POWER

(71) Applicant: DEERE & COMPANY, MOLINE, IL (US)

(72) Inventor: MANUEL BILLICH, DORNSTADT (DE)

(21) Appl. No.: 18/443,698

(22) Filed: Feb. 16, 2024

(30) Foreign Application Priority Data
Feb. 27, 2023 (DE) 102023104693.4

(51) Int. Cl. F15B 13/02; A01B 59/04; F15B 13/16

(52) U.S. Cl. CPC F15B 13/026; A01B 59/04; F15B 13/16

(57) ABSTRACT

A hydraulic assembly for supplying an attachment with hydraulic power of an agricultural towing vehicle, including a hydraulic work port for the passage of a hydraulic medium delivered by a pump, a pressure port, hydraulically connected to the work port, for delivering hydraulic power to the attachment, a hydraulic feedback port for receiving a hydraulic feedback pressure from the attachment, a signal port for delivering a feedback signal in dependence on the hydraulic feedback pressure, and a pressure sensor, between the hydraulic feedback port and the signal port, for conversion of the feedback pressure into the feedback signal.

### CROSS-REFERENCE TO RELATED APPLICATIONS

This application claims priority to German Patent Application No. 102023104693.4, filed Feb. 27, 2023, which is hereby incorporated by reference.

### FIELD OF THE DISCLOSURE

The disclosure relates to a hydraulic assembly for supplying an attachment with hydraulic power of an agricultural towing vehicle.

### BACKGROUND

Known hydraulic assemblies between the vehicle hydraulics and the attachment allow the pressure, or the delivery rate, to be hydraulically controlled in dependence on the requirements of the attachment. To this end, the hydraulic assembly has, inter alia, a hydraulic feedback port for receiving a hydraulic feedback pressure from the attachment.

### SUMMARY

The present disclosure is based on the object of further improving the hydraulic interaction of an agricultural towing vehicle with an attachment.

This object is achieved by a hydraulic assembly having the features of one or more of the following embodiments.

Further advantageous embodiments of the hydraulic assembly according to the disclosure can be found in one or more of the following embodiments.

According to one embodiment, a hydraulic assembly for supplying an attachment with hydraulic energy or power of an agricultural towing vehicle (e.g. a tractor) has a plurality of specific ports. These ports include a hydraulic work port for the passage of a hydraulic medium (e.g. oil), which is delivered by a pump, in the direction toward a pressure port, which is configured to deliver hydraulic energy to the attachment. In addition, a hydraulic feedback port is present in the hydraulic assembly, at which port a hydraulic feedback pressure from the attachment is received. In dependence on the feedback pressure, the hydraulic assembly generates a feedback signal, which is provided at a signal port of the assembly. Hydraulic-electric conversion of the feedback pressure into the feedback signal takes place between the hydraulic feedback port and the signal port.

An electrical feedback signal is thus present at the signal port of the hydraulic assembly. Accordingly, the hydraulic system of the towing vehicle can be controlled in dependence on the electrical feedback signal. Consequently, this electronic control at least partially replaces a conventional hydraulic control and thus simplifies the hydraulic coupling structure between the towing vehicle and the attachment. The reduction in hydraulic components makes the hydraulic coupling between the towing vehicle and the attachment less susceptible to faults and the work input of the attachment more efficient. Moreover, the electronic control permits shorter response times in the hydraulic system of the towing vehicle for the adjustment of the pressure, or volume flow, to be delivered.

In one embodiment, the above-mentioned hydraulic-electric conversion between the hydraulic feedback port and the electrical signal port has a device for pressure determination. The hydraulic feedback signal can thus be converted into an electrical feedback signal in a technically reliable manner. For example, the device for pressure determination has a pressure sensor or consists of such a pressure sensor. The device for pressure determination can thus be provided inexpensively in the form of a standard and reliable component.

For the purpose of efficient control of the hydraulic coupling between the towing vehicle and the attachment, the electrical signal port cooperates with an electrical control unit, which has a control port connected to the signal port.

The control unit has a control output, which is connected to a pump controller (e.g. electromagnetic) of a hydraulic pump unit of the hydraulic system of the towing vehicle. A pump output of the pump unit is hydraulically connected to the work port of the hydraulic assembly. A hydraulic variable displacement pump of the pump unit can thus be electronically activated in an efficient manner in order to adjust the pressure and/or volume flow, or delivery flow, with high accuracy.

In one embodiment, the control unit has a sensor input, to which a signal output of a pressure sensor is connected. A pressure input of the pressure sensor is hydraulically connected to the work port. A pressure sensor connected in the hydraulic circuit in this manner facilitates precise control in order to achieve a specific working pressure at the work port.

In one embodiment, a displacement sensor for detecting a displacement (e.g. change of position, movement) of the pump controller is connected between the pump controller of the pump unit and a sensor port of the electrical control unit. The displacement sensor can operate contactlessly or in contact with the object of the pump controller that is to be detected. By means of the displacement sensor, the control unit can evaluate specific signals in connection with a displacement of the variable displacement pump. In this manner, the control unit can activate the variable displacement pump even more precisely and thus improve the efficiency in the achievement of a specific working pressure at the work port.

In one embodiment, the work port and the pressure port are connected together directly without any hydraulic logic element, for example by means of a hydraulic line.

By contrast, in another embodiment, a hydraulic logic element is provided between the work port and the pressure port. The hydraulic logic element is an adjusting device for adjusting the hydraulic flow in the direction toward the attachment. By means of the adjusting device, the hydraulic flow, for example the pressure or the delivery rate, to the attachment can be limited to an adjustable value. As a result, the hydraulic power of the towing vehicle, for example where other functions are to be carried out at the same time, can be more efficiently controlled and prioritized without the need for on-board control by means of control valves or the like. In addition, the possibility of limiting the hydraulic flow to the attachment avoids unnecessary power losses. The correspondingly lower oil warming and the lower wear permit a higher vehicle efficiency and lower working costs.

The adjusting device has a hydraulic control valve which can be switched between a plurality of switch positions. For example, the control valve is configured as a continuously adjustable directional control valve having a plurality of intermediate positions and two end positions (e.g. proportional valve), so that the hydraulic flow can be adjusted precisely to the desired value. In its starting position, the directional control valve is in one of its end positions (e.g. the valve is closed in order to interrupt the hydraulic flow or the valve is fully open in order to allow the hydraulic flow to pass through). Activation or operation of the control valve is carried out electrically or mechanically.

The adjusting device has a pressure compensator. This measure assists with stable pressure conditions in the adjusting device. For example, the pressure at the pressure port can thus be regulated to a specific value, or the pressure can be maintained at that value, so that undesirable power losses are avoided in a technically simple manner.

In one embodiment, the pressure compensator and the control valve of the adjusting device are hydraulically combined with one another in such a manner that a delivery output of the pressure compensator is hydraulically connected to a delivery input of the control valve and/or a delivery output of the control valve is connected to a control input of the pressure compensator. As a result, the pressure conditions in the adjusting device, and thus also at the pressure port of the hydraulic assembly, are further stabilized. For example, the pressure compensator and the adjusting device permit a constant pressure difference between the work port and the pressure port of the hydraulic assembly.

In one embodiment, the work port, the pressure port, the feedback port and the signal port of the hydraulic assembly act as interface ports of an interface unit. The interface unit can thus be provided as a compact kit. In this respect, the hydraulic assembly, which can easily be installed, is also suitable for retrofitting to the towing vehicle or to the attachment.

Alternatively, at least some of the features of the hydraulic assembly are part of the on-board hydraulic system of the towing vehicle.

The above and other features will become apparent from the following detailed description and accompanying drawings.

### BRIEF DESCRIPTION OF THE DRAWINGS

The hydraulic assembly according to the disclosure will be explained in greater detail below with reference to the accompanying drawings. Components that correspond or are comparable in terms of their function are identified by the same reference signs. In the figures:

FIG. 1 shows, in the form of a block diagram, a first exemplary embodiment of the hydraulic assembly according to the disclosure;

FIG. 2a shows, in the form of a block diagram, a first exemplary embodiment of a hydraulic adjusting device within the assembly according to FIG. 1;

FIG. 2b shows, in the form of a block diagram, a further exemplary embodiment of the hydraulic adjusting device; and

FIG. 2c shows, in the form of a block diagram, a further exemplary embodiment of the hydraulic adjusting device.

### DETAILED DESCRIPTION

The embodiments or implementations disclosed in the above drawings and the following detailed description are not intended to be exhaustive or to limit the present disclosure to these embodiments or implementations.

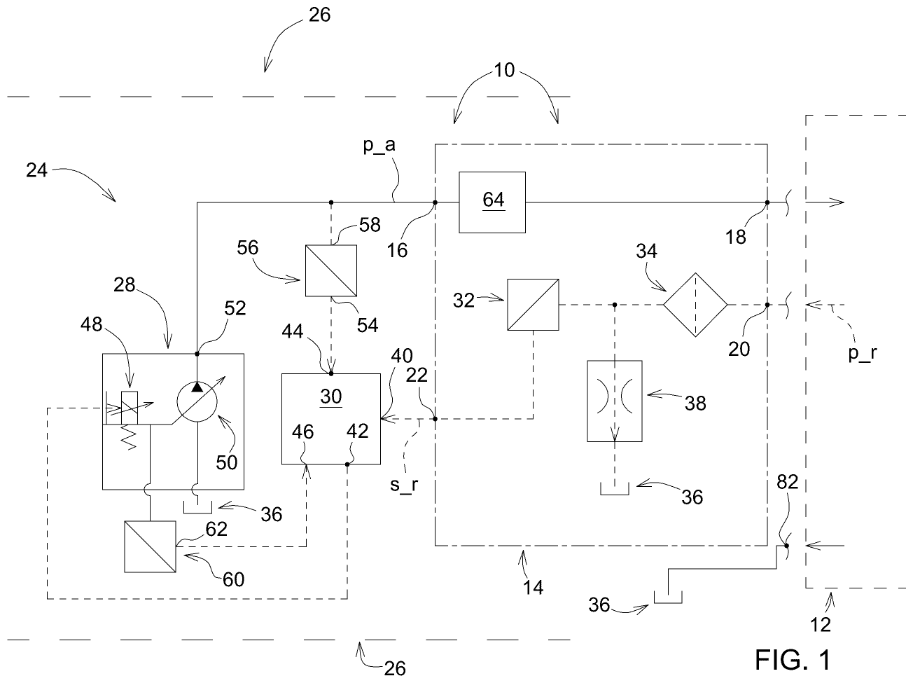

FIG. 1 shows a hydraulic assembly 10, which is connected to an attachment 12 indicated schematically by a broken line. The assembly 10 contains an interface unit 14 having a hydraulic work port 16, a hydraulic pressure port 18, a hydraulic feedback port 20 and an electrical signal port 22.

The interface unit 14 is configured as a kit and can then be connected (also retrospectively) to an on-board hydraulic system 24 of an agricultural towing vehicle 26, for example of a tractor. Alternatively, the interface unit 14 can be part of the on-board hydraulic system 24 of the vehicle.

The hydraulic assembly 10 serves to supply the attachment 12 with hydraulic power of the towing vehicle 26. The work port 16 serves for the passage of a hydraulic medium (e.g. oil) delivered by a pump unit 28. The pressure port 18 is hydraulically connected to the work port 16 and delivers hydraulic power to the attachment 12. The feedback port 20 receives a hydraulic feedback pressure p_r of the attachment 12.

The signal port 22 serves to deliver a feedback signal s_r to an electrical control unit 30 (e.g., a controller including a processor and memory) in dependence on the hydraulic feedback pressure p_r. Between the feedback port 20 and the signal port 22, a hydraulic-electric signal conversion takes place by means of a device for pressure determination in the form of a pressure sensor 32.

An optional filter 34 protects the hydraulic circuit from contamination. An optional throttle or flow control valve 38 arranged between the pressure sensor 32 and a hydraulic tank 36 allows the feedback pressure p_r to be reduced.

The control unit 30 has a control port 40 for receiving the feedback signal s_r. The control unit 30 further has a control output 42, a sensor input 44 and a sensor port 46.

The control output 42 is connected to an electrically operable pump controller 48 of the pump unit 28. The pump unit 28 has a hydraulic variable displacement pump 50 and is hydraulically connected to the work port 16 by way of a pump output 52.

A signal output 54 of a pressure sensor 56 is connected to the sensor input 44 of the control unit 30, while a pressure input 58 of the pressure sensor 56 is hydraulically connected to the work port 16. In this manner, the control unit 30 is able to detect the current pressure p_a at the work port 16 and adjust it if required by way of the pump controller 48.

A displacement sensor 60 is connected at a signal output 62 to the sensor port 46. The displacement sensor 60 detects a displacement of the pump controller 48, for example a change of position or a movement of the pump controller 48. The pump unit 28 can thus be controlled even more precisely by means of the control unit 30.

Different embodiments of a hydraulic port can be implemented between the work port 16 and the pressure port 18. This is represented symbolically by the placeholder 64.

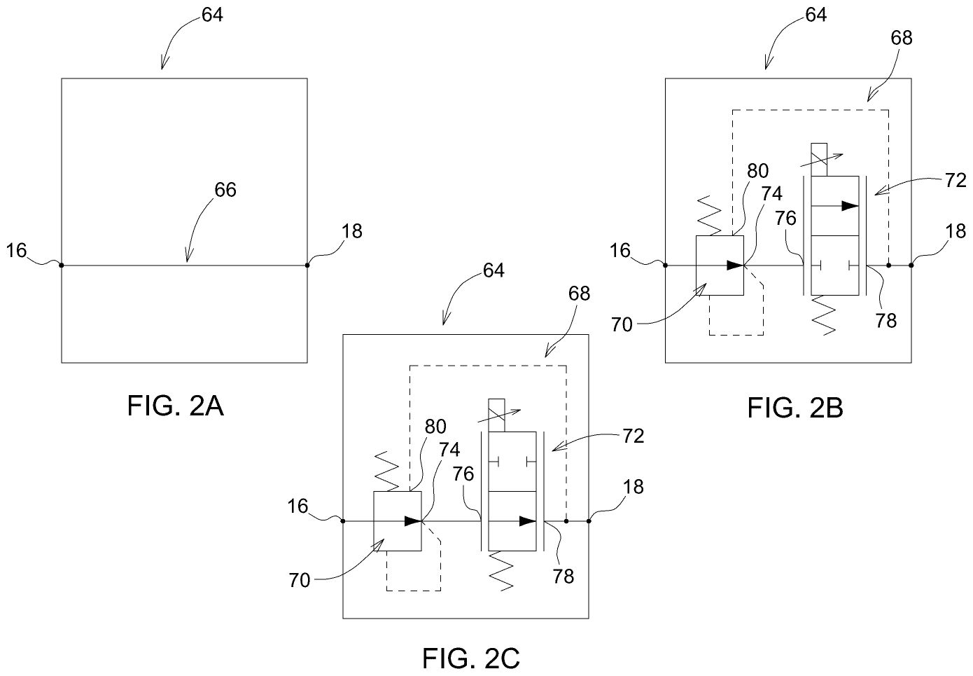

In one embodiment (FIG. 2a), the placeholder 64 is configured as a hydraulic line 66, so that the pressure at the two ports 16 and 18 is approximately equal.

However, it is expedient in different applications specifically to adjust or limit the hydraulic flow, for example the delivery flow and/or the pressure, at the pressure port and therefore to configure the placeholder 64 as a hydraulic logic element or adjusting device 68 (FIG. 2b, FIG. 2c).

To this end, the adjusting device 68 has a pressure compensator 70 and a control valve 72. The control valve 72 is configured as a hydraulic directional control valve which is continuously adjustable between a plurality of switch positions and has two end positions.

The pressure compensator 70 and the control valve 72 are hydraulically combined with one another in such a manner that a delivery output 74 of the pressure compensator 70 is hydraulically connected to a delivery input 76 of the control valve 72. A delivery output 78 of the control valve 72 is connected to a control input 80 of the pressure compensator 70.

By means of the described hydraulic logic element, a constant pressure difference can be ensured in the adjusting device 68. In dependence on the activation of the control valve 72, a maximum delivery flow can be maintained.

The control valve 72 is electrically operable. In other embodiments, it is operated mechanically, for example. Different starting positions are conceivable for the control valve 72. In one embodiment (FIG. 2b), the control valve 72 is blocked or interrupted for a hydraulic flow in its starting position. In another embodiment (FIG. 2c), the control valve 72 is fully open for a hydraulic flow in its starting position.

Finally, the hydraulic medium delivered by way of the pressure port 18, after the power conversion in the attachment 12, is fed back into the hydraulic tank 36 of the towing vehicle 26 by way of a return port 82 (FIG. 1).

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the figures, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A hydraulic assembly for supplying an attachment with hydraulic power of an agricultural towing vehicle, comprising:
a hydraulic work port for the passage of a hydraulic medium delivered by a pump;
a pressure port, hydraulically connected to the work port, for delivering hydraulic power to the attachment;
a hydraulic feedback port for receiving a hydraulic feedback pressure from the attachment;
a signal port for delivering a feedback signal in dependence on the hydraulic feedback pressure; and
a pressure sensor, between the hydraulic feedback port and the signal port, for conversion of the feedback pressure into the feedback signal.

2. The assembly of claim 1, further comprising an electrical control unit which has a control port connected to the signal port.

3. The assembly of claim 2, wherein the electrical control unit has a control output which is connected to a pump controller of a hydraulic variable displacement pump, and a pump output of the hydraulic variable displacement pump is hydraulically connected to the work port.

4. The assembly of claim 2, wherein the electrical control unit has a sensor input to which a signal output of a pressure sensor is connected, wherein an input of the pressure sensor is hydraulically connected to the work port.

5. The assembly of claim 3, wherein the electrical control unit has a sensor port to which a signal output of a displacement sensor for detecting a displacement of the pump controller is connected.

6. The assembly of claim 1, wherein an adjusting device for adjusting the hydraulic flow is hydraulically interposed between the work port and the pressure port.

7. The assembly of claim 6, wherein the adjusting device has a hydraulic control valve, which can be switched between a plurality of switch positions.

8. The assembly of claim 7, wherein the hydraulic control valve includes a proportional valve.

9. The assembly of claim 7, wherein the adjusting device has a pressure compensator.

10. The assembly of claim 7, wherein the adjusting device has a pressure compensator and a control valve.

11. The assembly of claim 9, wherein a delivery output of the pressure compensator is hydraulically connected to a delivery input of the hydraulic control valve, and a delivery output of the hydraulic control valve is connected to a control input of the pressure compensator.

12. The assembly of claim 1, wherein the work port, the pressure port, the feedback port and the signal port act as interface ports of an interface unit.
